(19) United States
(12) Patent Application Publication
(10) Pub. No.: US 2011/0307319 A1
(43) Pub. Date: Dec. 15, 2011

(54) SYSTEM AND METHOD FOR DESIGNING AND DISPLAYING ADVERTISEMENTS

(76) Inventors: Filippo Balestrieri, Mountain View, CA (US); Enis Kayis, East Palo Alto, CA (US); Shyam Sundar Rajaram, San Francisco, CA (US)

(21) Appl. No.: 12/815,732

(22) Filed: Jun. 15, 2010

(51) Int. Cl. G06Q 30/00

(52) U.S. Cl. 705/14.39; 705/14.52

(57) ABSTRACT

The present disclosure includes a system and method for designing and displaying advertisements. One or more targeted advertising methods include surveying potential customers to ascertain a price sensitivity and a likelihood of the potential customers purchasing products and/or observing venues, and clustering the potential customers according to product clusters based on the likelihood of purchasing products. Potential customers of each product cluster are clustered according to one or more venue clusters based on a likelihood of the potential customers of respective product clusters to observe the venues. An advertisement is designed for a venue corresponding to a particular venue cluster to include at least one product corresponding to a particular product cluster which is promotionally-priced based on the price sensitivity of potential customers of a particular venue cluster. An electronic display of the venue is modified to include the designed advertisement.

### BACKGROUND

Advertising, including Internet and other interactive media advertising, is a fast-paced and high-stakes industry. In the advertising industry, the advantages of presenting attractive, attention-getting, and memorable advertisements are well recognized. Such advertisements can increase brand recognition, improve sales, and can be an integral part of a public relations campaign.

The advent of advertising networks (e.g., the Internet, digital television transmissions, etc.) involves electronic types of media enabling communications to and from consumers and/or the potential customers. These advertising networks provide a unique mechanism for presenting advertisements to targeted segments of the population through an almost infinite array of advertising publishers. Each targeted population segment is likely to have different preferences and thus a different response to any particular advertisement. The large number of online publishers coupled with the potential to target multiple population segments makes it increasingly complex and expensive to optimize an advertising campaign.

Traditional print advertisements, and television and radio commercials, are examples of targeted marketing. That is, the products, context, and/or placement of the advertisement are tailored to the audience expected to be viewing the particular media. Traditional non-print media (e.g., television, radio) is capable of targeting an expected audience using time or day, since broadcasts are transitory unless recorded by the recipient for time-shifted viewing. In previous advertising schemes, the demographic profiling of the respective media drives the content selection and placement of the advertisements.

Advertisements provided via interactive media have afforded advertisers feedback that can be correlated to advertisement characteristics. Advertisers have harvested such feedback, using it to refine and optimize advertising campaigns in real time responsive to metrics such as click-through rates, browsing path-to-landing website, product placement in entertainment content, and/or other traditional advertising techniques. Interactive mechanisms have been used to determine consumer response and acceptance of advertisements in real time, but can involve an initial period of uncertainty due to the trial and error nature of real time online metrics.

In previous advertising approaches, advertising campaigns have been driven by an objective to sell a particular product, or group of products (e.g., targeted products). The objective to sell more of the targeted product is often designed to increase sales at a usual price for the product (e.g., sell more products at its existing price). Sometimes, advertising campaigns involve an across-the-board pricing promotion, such as sale pricing or discounts during a finite time period of the promotion (e.g., sell more product at a lowered price). Once generically priced, advertisements are devised for the targeted products and placed where calculated to have the best opportunity to reach a targeted market segment thought most likely to be interested in purchasing the targeted product(s).

Product brand managers are tasked with the responsibility to increase sales and/or profits with respect to a particular product line, which results in a narrow product-marketing focus (e.g., find ways to sell more of the particular product). Multi-product sellers can maximize sales/profits in aggregate by attracting customers with competitive pricing on some products in order to present higher-margin products to the attracted customers. Previous advertising approaches have occasionally employed cross-product promotions (e.g., selling bacon in close association with selling eggs). Sellers typically start with a product and attempt to find customers to buy that product, rather than starting with segments of potential customers and attempting to determine from them what products to sell, where to sell those products, and at what price.

### BRIEF DESCRIPTION OF THE DRAWINGS

FIG. 1 is a relationship diagram illustrating product clustering according to one or more example embodiments of the present disclosure.

FIG. 2 is a relationship diagram illustrating venue clustering according to one or more example embodiments of the present disclosure.

FIG. 3 is a diagram illustrating an example webpage layout according to one or more example embodiments of the present disclosure.

FIG. 4 is a networked advertising system according to one or more example embodiments of the present disclosure.

### DETAILED DESCRIPTION

The present disclosure includes a system and method for designing and displaying advertisements. One or more embodiments of a targeted advertising method include surveying potential customers to ascertain a price sensitivity and a likelihood of the potential customers purchasing certain products and/or observing venues and clustering the potential customers according to product clusters based on the likelihood of purchasing products. Potential customers of each product cluster are clustered according to one or more venue clusters based on a likelihood of the potential customers of respective product clusters to observe the venues. An advertisement is designed for a venue corresponding to a particular venue cluster to include at least one product corresponding to a particular product cluster which is promotionally-priced based on the price sensitivity of potential customers of a particular venue cluster. An electronic display of the venue is modified to include the designed advertisement.

According to one or more embodiments, a non-transitory computer readable medium having computer-executable instructions stored thereon for execution by a processor to perform a method that includes separating potential customers into a plurality of product clusters, each product cluster corresponding to one of a plurality of product classifications, potential customers of a product cluster indicating a preference for purchasing products of the corresponding product classification. The method further includes clustering potential customers of a product cluster into venue clusters based on likelihood of a potential customer of the product cluster to visit a venue, and determining a price sensitivity associated with the venue. Advertisements are designed so that they have content associated with the product classification are displayed at the venue associated with each venue cluster of a product cluster corresponding to the product classification. The pricing associated with a particular advertisement is determined based on the price sensitivity associated with the venue at which the particular advertisement is displayed.

The term “impression,” as used herein, refers to the presentation of an online advertisement (e.g., a banner ad) to a user via an electronic display. As used herein, an electronic display is intended to include visual and/or auditory communications. Therefore, electronic displays can include computer monitors, televisions, portable communication device screens and speakers, radio, and other electronic communication means.

The term “online,” as used herein, refers to an advertising network. As such, online can refer to the Internet or other computer network; television broadcasts via cable, satellite, or earth antennae; radio broadcasts; portable communication device communication system such as satellite, cellular telephone, Wi-Fi, or other networked communications channels.

The methods and systems of the present disclosure can be used to overcome the “cold start” problems associated with designing advertisements. Advertising design, advertising placement, including product selection and pricing within the advertisements, can be systematically accomplished in order to improve expected results prior to launch a multi-product sales endeavor (e.g., website, campaign). For example, a new multi-product seller may not be able to rely on historical sales data to make targeted advertising decisions, since it does not exist. Instead, appropriate survey(s) can be used to gather information potential customers about product preferences and pricing sensitivity. The survey information can be used to cluster potential customers according to certain products. Further survey information regarding the potential customer price sensitivity and venue viewing/browsing behavior can be used to target products and pricing schemes to particular venues where they might be most effective. Pricing schemes can include discounts and coupons, or other offers that can impact pricing, so that different net pricing can be presented to different audiences of potential customers, despite a single seller's venue (e.g., website) that reflects standard base pricing (e.g., from which the discounts, promotions, etc. are taken).

Online advertisement campaigns can include one or more methods for publishing the advertisements, including search engine advertising, desktop advertising, online advertising directories, advertising networks, message (e.g., email, IM, SMS, MMS) advertising, and the like. Also, the advertisements themselves, can be published in different ways, including, but not limited to, text only ads, banner ads, popup ads, pop-under ads, interstitial ads, floating ads, expanding ads, wallpaper ads, video ads, audio ads, animated ads, trick banner ads, map ads, and/or the like.

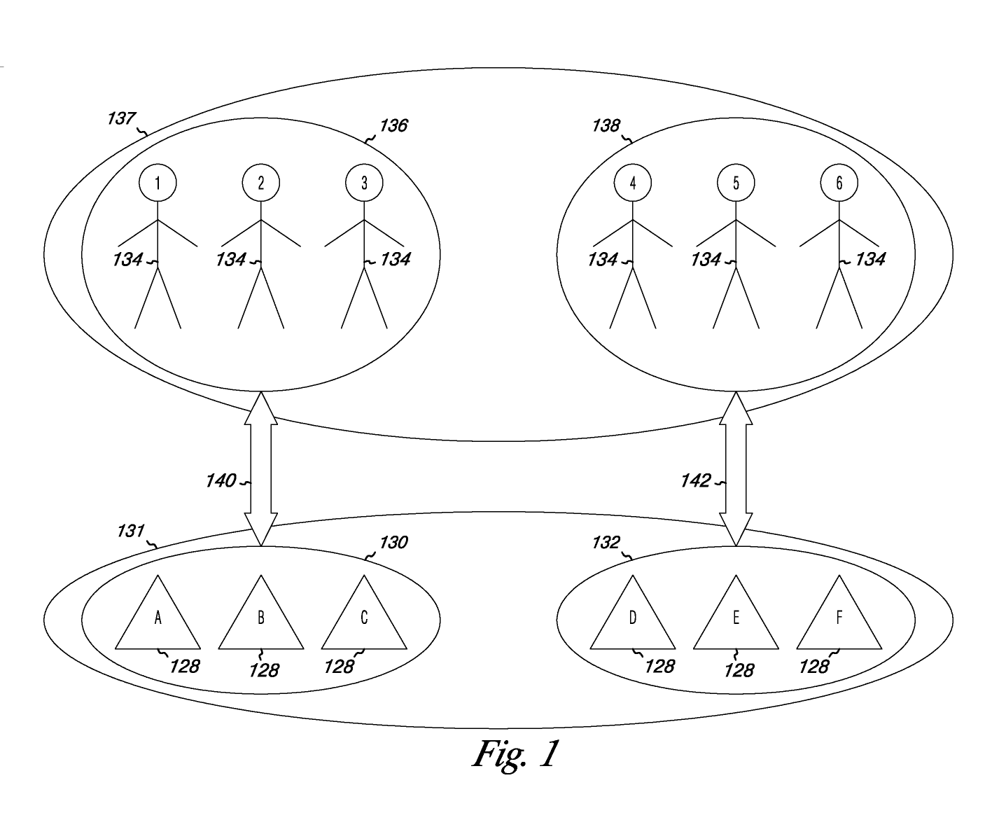

FIG. 1 is a relationship diagram illustrating product clustering according to one or more example embodiments of the present disclosure. The following discussion will be made in the context of a multi-product seller that maintains a web-store and advertises products from the web-store through Internet banner advertisements (e.g., ads). However, embodiments of the present disclosure are not limited to this example, and the system and method of the present disclosure may be implemented in many other configurations, and applied to many other products and/or advertising circumstances. While the following example utilizes products to illustrate the system and method of the present disclosure, the features and concepts presented herein are likewise applicable to services, as well as other tangible and intangible items of commerce.

Different products appeal to different kinds of customers. Objectives of a seller include attracting customers, maximizing the likelihood that they make a purchase, and maximizing the profit realized by such purchases. Among the variables confronting a seller desiring to advertise products in a finite (e.g., space, time) banner ad can generally include how to design one or more banner ads and which products to advertise in particular banner ads, including how to price the subject matter of the banner ads, and where to place the designed banner designed ads. Placement of banner ads in this example embodiment includes which website(s) on which to place a particular banner ad, and can include where on a particular website the banner ad appears.

Briefly stated, the system and method of designing and displaying advertisements, described further below, generally concerns three seller-controlled variables associated with advertising: ad content, ad placement, and promotion and/or pricing of the products associated with the ad (e.g., ad-specific promotion/pricing). Ad content involves determining which products to advertise from among a collection of products, and/or which products to advertise together in a same banner ad. Ad content can also include the design of links from a particular ad. Different banner ads, or differently-placed banner ads, may lead to different web-store landing pages. Thus, the ad content can also involve the selection of products that are associated with the landing page to which a particular banner ad is linked. For example, one banner ad for software may land a user on an accounting software page of a software web-store, while another differently-placed, but similar-looking, banner ad may land a user on a word processing software web page of the software web-store. Ad content can also include the look and feel of a particular ad, determined by a number of modifiable elements of the banner ad including text, background color, foreground color, size, font size, font type, bitmaps, vector images, graphics, icons, movies, videos, audio, animation, logo, template, and/or the like, and combinations thereof.

Ad placement involves where to locate a particular banner ad. Ad placement decisions can include determining which website page to associate a particular banner ad (e.g., of a given content), and/or the geographic location within a particular website to place the banner ad with respect to the other content of the website. Ad-specific promotion/pricing involves the pricing at which the products of a particular banner ad are offered. Pricing decisions can include determining a price point, providing discounts, establishing promotions (e.g., buy one get one free), and/or offering coupons, among other marketing techniques.

According to one or more embodiments of the present disclosure, a seller collects information about the preferences of potential customers, including information indicative of product preferences, price elasticity, and Internet browsing behavior. The potential customer information may be collected through an appropriately designed survey, or set of surveys, which can be implemented to mitigate a “cold start” problem experienced by new sellers. The one or more surveys can be structured or unstructured, for example, a survey can be implemented as a focus group representative of potential customers.

A first (e.g., product) clustering analysis is performed on the collected data in order to identify the products, or categories of products, by which the group of potential customers can be separated in terms of their purchasing preferences. FIG. 1 illustrates a number of potential customers 134. The population 137 of potential customers 134 is shown divided into two groups, a first group of people 136 and a second group of people 138. A quantity of products 128 are also shown in FIG. 1. The collection 131 of products 128 is shown divided into two classifications, a first product classification 130 and a second product classification 132. A first relationship 140 is indicated between the first group of people 136 and the first product classification 130. A second relationship 142 is indicated between the second group of people 138 and the second product classification 132.

The reader will appreciate that through the collected information (e.g., by survey), product clustering analysis can determine that the first group of people 136 have a preference for purchasing products of the first product classification 130, and that the second group of people 138 have a preference for purchasing products of the second product classification 132. That is, through product clustering analysis, products and/or categories of products can be identified (e.g., clusters identification) that allow separating the potential customers into groups based on their purchasing preferences.

While the product clustering analysis discussion above with respect to FIG. 1 illustrates the features of the present disclosure using hard clustering, where membership in a particular cluster is mutually exclusive of membership in other clusters (e.g., each survey respondent belongs to one and only one product cluster), one or more embodiments of the present disclosure may be implemented employing soft clustering techniques. Soft clustering associates members of a population (e.g., survey respondents) with respective groups (e.g., product cluster) by determining a probability (e.g., weight) that a particular member belongs to particular groups. In this manner, a person may be associated with multiple groups. For example, using a soft clustering technique person 1 (FIG. 1 at 134) may have a 70% probability of being clustered with the first product classification 130, and a 30% probability of being clustered with the second product classification 132. As the reader will appreciate, each person (e.g., survey respondent) can be associated with a probability distribution across different product clusters.

For example, assume product A shown in FIG. 1 is office supplies, product B is business software, product C is computer equipment, product D is car parts, product E is motor oil, and product F is tires. It is determined through survey that people 1-3 have a preference for purchasing products A-C, and people 4-6 have a preference for purchasing products D-F. The survey may be a focus group including people 1-6. From the information collected via the focus group, product clusters can be determined, such as products A-C being the first product classification (e.g., business products), and products D-F being in the second product classification 132 (e.g., vehicle products). These product classifications allow people 1-6 to be separated into the first group of people 136 corresponding to the first product classification 130, and the second group of people 138 corresponding to the second product classification 132. Groups of people (e.g., 136, 138) corresponding to a respective product classification (e.g., 130, 132) may also be referred to herein as a product cluster, and the process of determining which people correspond to which products may be referred to as product clustering.

Groups of people can include more, or fewer people, and product classifications can include more, fewer, or different products or services, and the like. Products that do not allow differentiating the people into different groups may, or may not, be included in product classifications. For example, if all of people 1-6 expressed a preference for purchasing perfume, perfume cannot be used as a basis for separating people 1-6 into groups. As such, perfume may, or may not, be included in each of the product classifications. As illustrated in the present example, the first 130 and second 132 product classifications do not include a perfume product. Products for which no people express a buying preference can be excluded from product classifications, since expending limited resources to advertise products to people who are unlikely to purchase them is economically inefficient.

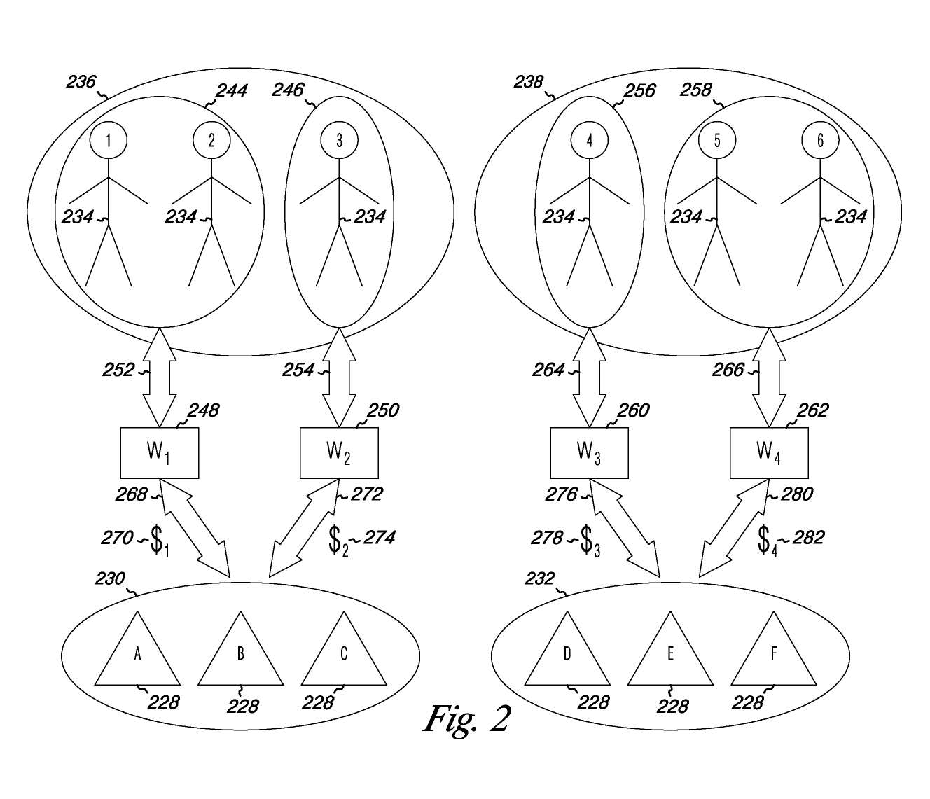

FIG. 2 is a relationship diagram illustrating web site clustering according to one or more example embodiments of the present disclosure. According to one or more embodiments of the present disclosure, each product cluster (e.g., group of people) can be further clustered in terms of their likelihood to visit (e.g., view) one or more particular venues (e.g., website, webpage, content provider, gaming application, etc.). For example, the population of people associated with each product cluster can be further clustered in terms of their online browsing behavior to determine which website(s) they are likely to visit. As shown in FIG. 2, a first product cluster 236 includes people 1-3, and a second product cluster 238 includes people 4-6. Product cluster 236 can be further clustered from survey information (e.g., obtained by written survey including questions indicative of a person's browsing behavior, online survey, online behavior monitoring, focus group, etc.) to determine that people 1 and 2 indicate a propensity to visit website W1, and person 3 indicates a propensity to visit website W2. From this information, persons 1 and 2 can be further clustered into a first website cluster 244 having a correspondence 252 to website W1 248, and person 3 can be further clustered into a second website cluster 246 having a correspondence 254 to website W2 250.

Similarly, the second product cluster 238 can be further clustered from survey information to determine that person 4 indicates a propensity to visit website W3, and people 5 and 6 indicate a propensity to visit website W4. Thus by website clustering the constituents of a product cluster, person 4 can be further clustered into a third website cluster 256 having a correspondence 264 to website W3 260, and persons 5 and 6 can be further clustered into a forth website cluster 258 having a correspondence 266 to website W4 262. While for ease of illustration of the present method, the example illustrated in FIG. 2 shows that each website cluster corresponds to a unique website (i.e., hard clustering). However, embodiments are not so limited, and soft clustering techniques may be used with respect to venue cluster, as was previously discussed in the context of product clusters. For example, website cluster 256 may have been found to correspond to website W2 along with website cluster 246. That is, there can be overlap in websites that correspond to particular website clusters.

Furthermore, while a website cluster is shown in FIG. 2 corresponding to a single website, embodiments of the present disclosure are not so limited. That is, a website cluster may correspond to a plurality of websites, some or all of which may overlap and correspond to other website clusters. Website clusters may include more, or fewer, people than illustrated in FIG. 2. And the population of each product cluster may be further clustered into more, or fewer sub-clusters (e.g., website clusters) than shown in FIG. 2.

In the example illustrated in FIG. 2, each product cluster is further clustered into a sub-cluster (e.g., website cluster), the website clusters having correspondence to particular websites. However, embodiments of the present disclosure are not so limited, and the sub-clusters of product clusters may be additionally or alternatively (or a combination of both) based upon other media or networked advertising systems than websites. For example, product clusters may be sub-clustered based on broadcast content (e.g., television shows, radio shows), print media, geography of reception device or user, type of reception device, advertising network (e.g., cellular phone carrier, broadcast network, etc.), or any other appropriate classification to further differentiate groups of people from one another that might influence buying behavior and/or cost of advertising impressions. Further clustering (e.g., sub-clustering) may be accomplished using hard and/or soft clustering techniques.

Additionally, the sub-clusters determined from product clusters may further be clustered as well any number of times (e.g., sub-sub-clusters, sub-sub-sub-clusters, etc.). For example, sub-clusters such as the website clusters, may be further clustered based on the date and/or time of day that a website is visited. From such date/time clusters, the reader will appreciate that different banner ads can be displayed on a given website depending on when certain people are most likely to visit the given website. Of course, the date/time clusters can be further clustered, if necessary, according to additional criteria that might differentiate product mix and/or pricing, and the like.

According to one or more embodiments of the present disclosure, each sub-cluster is further profiled in terms of price elasticity. Profiling can be accomplished via survey, for example, from questions indicative of price sensitivity and/or purchasing attitudes. The price elasticity analysis may be determined from survey, including focus group(s). According to various embodiments, each website is profiled in terms of price elasticity. The reader will appreciate that profiling a sub-cluster that has a correspondence to one or more websites, or profiling website directly, can determine a website-specific price elasticity. Profiling a sub-cluster that corresponds to a number of websites can associate the resulting price elasticity for the website cluster to more than one website. While FIG. 2 illustrates hard clustering of the product cluster populations to websites, soft clustering techniques can alternatively be implemented.

Referring to FIG. 2, a first product classification 230 may correspond to first product cluster 236, and a second product classification 232 may correspond to a second product cluster 238. As such, the first product classification 230 corresponds to the first 244 and second 246 website clusters, and the second product classification 232 corresponds to the third 256 and forth 258 website clusters respectively.

Having determined that website cluster 244 has a preference for purchasing products of the first product classification 230 and a propensity to visit website W1, an advertisement (e.g., banner ad) can be designed to include products from the first product classification 230 and placed on website W1. That is, there is a correspondence 268 between the first product classification 230 and website W1. As the first website cluster 244, or website W1, has been profiled to determine a price elasticity (indicated in FIG. 2 by the symbol at 270), the products of a banner ad for products of the first product classification 230 displayed on website W1 (e.g., to website cluster 244) can be promotionally-priced (e.g., promoted with a special discount, coupon, or other offer) based on price elasticity 270.

Website W2 may have been determined (e.g., by profiling) to have a same, or different, price elasticity 274 than website W1. Thus, the products of a banner ad for products of the first product classification 230 displayed on website W2 (e.g., to website cluster 246) can be promotionally-priced based on price elasticity 274. Appropriately designed questions in a survey allow profiling the people belonging to a website cluster (or sub-cluster, in a data-rich environment) in terms of their price sensitivity. It is intended that such surveying of people likely to visit a particular venue (e.g., website) profiles the venue, since the price sensitivity attributes are subsequently attributed to other users that might also visit the venue. It should be noted however, that profiling the venue (i.e., the users of the venue) for its price elasticity is different that determining a price elasticity for a particular product. For example, conventional economic theory indicates that commodity products have a different price elasticity than luxury goods. Thus, a price elasticity for the product itself is determined. In the present disclosure, a price elasticity is determined for the venue (e.g., website). The venue price elasticity can then be applied to some, or all, of the products of a banner ad placed at the particular venue (e.g., regardless of whether they are a commodity item or luxury good).

Price elasticity of the venue is used to determine promotional pricing of the products included in the banner ad. Pricing, as used herein, can include the price set, discounts, coupons, promotions, rewards, and the like. Pricing determined based on the price elasticity of the venue may, but need not, be applied to all products of a particular banner ad displayed at the venue. That is, discounts may be applied to some items in a particular banner ad, while other items included in the same banner ad may be offered at full (e.g., un-discounted) price. Alternatively, all items of a particular banner ad may be uniformly discounted.

A banner ad may, but need not, indicate a price within the banner ad to have the pricing of the products included in the banner ad be based on the price elasticity of the venue at which the banner ad is displayed. For example, a banner ad may be linked to a sellers store, and the landing page may that reflects the different pricing (e.g., as determined based on the price elasticity of the venue from which a potential customer originated).

FIG. 2 illustrates that the second product classification 232 may correspond to the second product cluster 238. As such, the second product classification 232 corresponds to the third 256 and forth 258 website clusters. Having determined that website cluster 256 has a preference for purchasing products of the second product classification 232 and a propensity to visit website W3, an advertisement (e.g., banner ad) can be designed to include products from the second product classification 232 and placed on website W3. That is, there is a correspondence 276 between the second product classification 232 and website W3. As the third website cluster 256, or website W3, has been profiled to determine a price elasticity (indicated in FIG. 2 by the symbol at 278), the products of a banner ad for products of the second product classification 232 displayed on website W3 (e.g., to website cluster 256) can be priced based on price elasticity 278.

Likewise, there is a correspondence 280 between the between the second product classification 232 and website W4 based upon the correspondence between the second product classification 232 and website cluster 258, and correspondence between website cluster 258 and website W4, which has been profiled to have a particular price elasticity 282.

The reader will appreciate that advertisements (e.g., banner ads) can be created by grouping together products from a particular product classification (e.g., 230, 232). That is, which products to include in a particular banner ad are determined from the product classifications used to determine the product clusters. Multiple banner ads may be created from products of a particular product classification. For example, one banner ad may include product A alone. Another may include products A and C, another B and C, and yet another may include all products A-C.

For a given product classification, banner ads featuring some or all of the products of the given product classification can be distributed across websites for which there is a correspondence (e.g., 268, 272). Conversely, banner ads featuring some or all of the products of the given product classification need not be distributed across websites for which there is no correspondence (e.g., do not place banner ads for products of product classification 230 on websites W3 and W4). For a given content, banner ads are associated with different price offerings, promotions, and/or discounts depending on the website at which a particular banner ad is displayed, as prescribed by the price elasticity analysis of the respective destination website. That is, banner ads with the same product content can have different pricing depending on where (e.g., which website) the banner ad is displayed.

The reader will appreciate that in utilizing the systems and methods for displaying banner ads disclosed herein, one can prioritize banner ad placement according to economic, or other, criteria. For example, a fixed marketing budget can be allocated to different banner ads content, and/or banner ad placements, according to given placement prices, and expected revenues.

The clustering analysis to determine product clusters, and/or further clustering (e.g., sub-clusters, sub-sub-clusters, etc.) can be performed using, for example, any appropriate state of the art hard or soft clustering techniques such as K-means, probabilistic latent semantic indexing, and/or latent Dirichlet allocation.

In one or more embodiments of the present disclosure, where relevant information is not available, not yet available, or of insufficient quality (e.g., a data poor environment), product clusters (e.g., FIG. 2 at 236 and 238) can be profiled in terms of price elasticity and/or web browsing behavior. The entire population (e.g., FIG. 1 at 137) can be clustered in terms of web browsing behavior and profiled in terms of price elasticity (e.g., rather than each product cluster individually). Then, by comparing the price elasticity results from the entire population and the individual product clusters, a determination is made as to which provides a strongest signal of price elasticity. Based on the comparison, pricing (e.g., discounts) can be distributed across banner ads if the signal from the product cluster analysis is stronger, or distributed across websites if the signal from the entire population analysis is stronger.

According to one or more embodiments, the banner ad content is not specific products per se, but rather coupons and/or discounts (e.g., applicable to all products of a particular web-store) that are distributed through the banner ads (e.g., the content of the banner ads is the discount rather than products). In this manner, the product pricing remains constant at the web-store, but discounts are available from the standard product pricing based on the banner ad which appears at various other websites (e.g., W1-W4 in FIGS. 1 and 2). The reader will appreciate that the particular discount is thereby correlated to the price sensitivity of the potential customers frequenting the various other websites, and avoids the pricing shown at the web-store website from being different depending on how a potential customer arrived at the web-store. With differing coupons/discounts, the effect achieved is the same in a more socially-acceptable manner, and without confusing the customer.

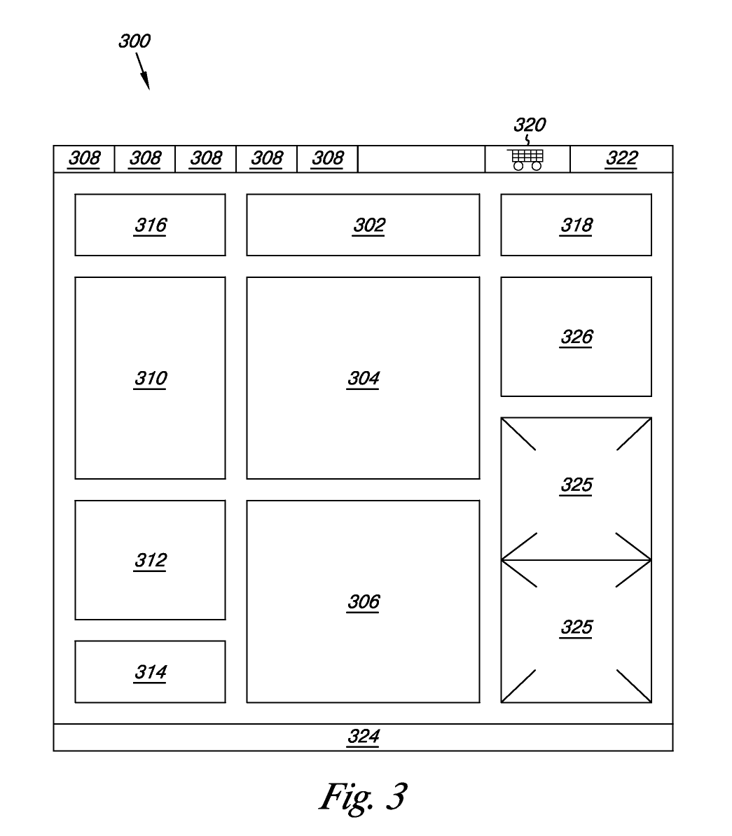

FIG. 3 is a diagram illustrating an example webpage layout according to one or more example embodiments of the present disclosure. Ad placement can include location on a given webpage or within a given website. Webpage 300 illustrates one of an unlimited number of arrangements of webpage areas. For example, webpage 300 can include a title area 302, a first main content area 304, and a second main content area 306. Webpage 300 can also have a main links area 310, a secondary links area 312, and a detailed links area 314. Webpage 300 can also have a secondary content area 326, and perhaps a number of image areas 325, as well as a footer area 324. Webpage 300 may include several navigation areas, such as page tabs 308, a shopping cart link area 320, and/or other website page navigation tool areas 322. Webpage 300 may have dedicated prominent space for placement of banner ads (e.g., 316, 318), or may allow banner ads to be placed at some or all of the aforementioned areas. Pricing for placement of banner ads in a particular area may vary depending on the webpage area, and/or webpage within the website at which the banner ad is displayed (e.g., banner ad placement on a home webpage verses a non-home webpage). Other webpages may have different arrangements and areas with different size, location and other visual characteristics.

According to one or more embodiments of the present disclosure, product clusters (or other sub-clusters) may be further clustered based on webpage and/or webpage area. That is, website clusters discussed above with respect to FIG. 2 may be further clustered based on webpage clustering (e.g., the webpage within a particular website), and/or webpage location (e.g., the area within a particular webpage). For example, price elasticity may be determined for banner ad placement in area 318 and 324 from survey information that indicates some people of a product cluster (or website cluster, etc.) may utilize coupons displayed on a given website in area 318 differently than others might utilize coupons displayed on a given website in area 324. The pricing for placing banner ads at each area may also be different (e.g., cheaper at the bottom of a webpage), leading to different pricing to reflect the different cost inputs to sell products.

The reader will appreciate that the method for displaying banner ads described herein allows a seller to maximize the likelihood of potential customers to purchase by identifying groups of people, who may have different tastes, and placing banner ads with appropriate product offerings and/or discounts at appropriate websites. By further separating potential customers having different price elasticity characteristics and/or purchasing attitudes (that may not be directly observable) based on their browsing behaviors (which are observable), discounts and promotions can be placed with as much granularity as desired to be most efficient. The term “efficient” as used herein, refers to the number of potential consumer interactions with a particular online advertisement that is published either singly, or as part of a campaign. Online advertisements can be impressions, browse-overs, click-throughs, among others presented electronically, such as by a visual display or auditory broadcast. Efficiency may also include financial considerations, such as the number of interactions per unit cost for ad design and/or placement.

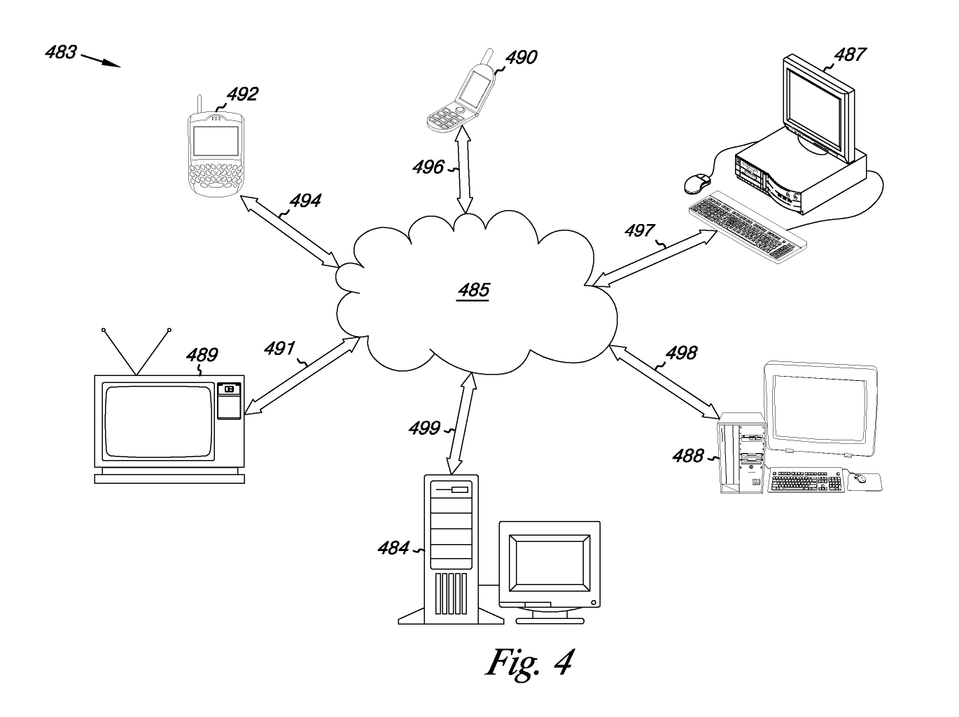

FIG. 4 is a networked advertising system according to one or more example embodiments of the present disclosure. The networked advertising system 483 can include a communication network 485 having a number of electronic devices communicatively coupled thereto. As shown in FIG. 4, communication network 485 can have a first mobile device 492, a second mobile device 490, a first client device 487, a second client device 488, a server 484, and a media device 489 (e.g., television, radio) communicatively coupled to network 485. Each system component can be coupled to network 485 by a wired or wireless communication channel. For example, the first mobile device 492 is shown being coupled to the network 485 by a first communication channel 494; second mobile device 490 is shown being coupled to the network 485 by a second communication channel 496; first client device 487 is shown being coupled to the network 485 by a third communication channel 497; second client device 488 is shown being coupled to the network 485 by a forth communication channel 498; server 484 is shown being coupled to the network 485 by a fifth communication channel 499; and media device 489 is shown being coupled to the network 485 by a sixth communication channel 491.

Not all of the components and/or communication channels illustrated in FIG. 4 are required to practice the system and method of the present disclosure, and variations in the arrangement, type, and quantities of the components may be made without departing from the spirit or scope of the system and method of the present disclosure. Other advertising network components can include personal computers, laptop computers, mobile devices, cellular telephones, personal digital assistants, video game consoles, or the like. Communication channels may be similar to, or different from, other communication channels.

Generally, first and second mobile devices 492 and 490, and first and second client devices 487 and 488, and server 484 may include virtually any computing device capable of connecting to another computing device to send and receive information, including web requests for information from a server device, and the like. Media device 489 may also be a computing device capable of connecting to another computing device to send and receive information, including web requests for information from a server device; or may only be configured to receive information (e.g., broadcasts, games) that include advertisements.

First and second mobile devices 492 and 490, first and second client devices 487 and 488, and/or media device 489 may further include a client application that is configured to manage various actions, for example, a web browser application that is configured to enable an end-user to interact with one or more servers (e.g., server 484) and/or other devices and/or applications via network 485.

Server 484 may include a server application that is configured to manage various actions, for example, a web-server application that is configured to enable an end-user to interact with server 484 via network 485. In one or more embodiments, server 484 may be configured to manage advertising resources such as databases, and other means for determining and responding to website and/or advertising performance statistics and/or other metrics. Server 484 can include one or more processors, and non-transitory computer-readable media (e.g., memory) storing instructions executable by the one or more processors. That is, the executable instructions can be stored in a fixed tangible medium communicatively coupled to the one or more processors. Memory can include RAM, ROM, and/or mass storage devices, such as a hard disk drive, tape drive, optical drive, solid state drive, and/or floppy disk drive.

The non-transitory computer-readable media can be programmed with instructions such as an operating system for controlling the operation of server 484, and/or applications such as a web page server, mathematical computation programs (e.g., financial analysis packages), and/or advertisement generation, modification, and/or distribution application. The operating system and/or applications may be implemented as one or more executable instructions stored at one or more locations within volatile and/or non-volatile memory, Server 484 may also include an internal or external database, or other archive medium for storing, retrieving, organizing, and otherwise managing advertisements, advertising campaigns, and elements thereof.

Mobile devices 492 and 490 can also be client devices and include a processor in communication with a non-transitory memory, a power supply, one or more network interfaces, an audio interface, a video interface, a display, a keyboard and/or keypad, and an optional global positioning systems (GPS) receiver. Mobile devices 492 and 490 may optionally communicate with a base station (not shown), or directly with another network component device. Network interfaces include circuitry for coupling the mobile device to one or more networks, and is constructed for use with one or more communication protocols and technologies including, but not limited to, e-mail, Internet, and/or wireless communication protocols. The network interface is sometimes known as a transceiver, transceiving device, or network interface card (NIC).

Applications on client devices may include computer executable instructions stored in a non-transient medium which, when executed by a processor, provide such functions as a web browser to enable interaction with other computing devices such as a server, and/or the like.

In certain embodiments, the above discussed advertisement management applications can be used, configured, controlled, and/or the like though a web browser by an advertiser. For example, the web browser can communicate with a web server running server-side advertisement management applications to manage Internet or other online advertising campaigns. However, in other embodiments, an advertiser may use locally installed applications, an ASP or third party may manage an advertising campaign for the advertiser, and/or the like. It is also recognized that the above discussed advertising management applications and elements thereof may be used separately, together, or in any suitable combination.

The above specification, examples and data provide a description of the method and applications, and use of the system and method of the present disclosure. Since many embodiments can be made without departing from the spirit and scope of the system and method of the present disclosure, this specification merely sets forth some of the many possible embodiment configurations and implementations.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

Various embodiments of the system and method for displaying advertisements have been described in detail with reference to the drawings, where like reference numerals represent like parts and assemblies throughout the several views. Reference to various embodiments does not limit the scope of the system and method for displaying advertisements, which is limited only by the scope of the claims attached hereto. Additionally, any examples set forth in this specification are not intended to be limiting and merely set forth some of the many possible embodiments for the claimed system and method for displaying advertisements.

Throughout the specification and claims, the meanings identified below do not necessarily limit the terms, but merely provide illustrative examples for the terms. The meaning of “a,” “an,” and “the” includes plural reference, and the meaning of “in” includes “in” and “on.” The phrase “in an embodiment,” as used herein does not necessarily refer to the same embodiment, although it may.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A targeted advertising method, comprising:
surveying potential customers to ascertain a price sensitivity and a likelihood of the potential customers purchasing products and/or observing venues;
clustering the potential customers according to product clusters based on the likelihood of purchasing the products;
clustering potential customers of each product cluster according to one or more venue clusters based on the likelihood of the potential customers of respective product clusters to observe the venues;
designing an advertisement for a venue corresponding to a particular venue cluster to include at least one product corresponding to a particular product cluster which is promotionally-priced based on the price sensitivity of potential customers of a particular venue cluster; and
modifying an electronic display of the venue to include the designed advertisement.

2. The method of claim 1, wherein the venue is a website.

3. The method of claim 1, wherein the advertisement is a banner ad.

4. The method of claim 1, wherein the product clusters and/or one or more venue clusters are hard clusters with mutually exclusive membership.

5. The method of claim 1, wherein the product clusters and/or one or more venue clusters are soft clusters with non-mutually exclusive probabilistic membership.

6. A non-transitory computer readable medium having computer-executable instructions stored thereon for execution by a processor to:
cluster potential customers into a plurality of product clusters, each product cluster corresponding to one of a plurality of product classifications, potential customers of a product cluster having indicated a preference for purchasing products of the corresponding product classification;
cluster potential customers of a product cluster into venue clusters based on likelihood of a potential customer of the product cluster to observe venues;
determine a price sensitivity for potential customers with respect to the venues; and
display an advertisement having content associated with the product classification at the venues,
wherein promotional pricing associated with a particular advertisement is determined based on the price sensitivity associated with the venues at which the advertisement is displayed.

7. The non-transitory computer readable medium of claim 6, wherein the certain venues are websites.

8. The non-transitory computer readable medium of claim 7, wherein the advertisement is a banner ad.

9. The non-transitory computer readable medium of claim 8, wherein determining the price sensitivity associated with the venues includes determining a price elasticity of users visiting the venues.

10. The non-transitory computer readable medium of claim 9, wherein the content is a coupon offering a discount on products associated with a product classification.

11. The non-transitory computer readable medium of claim 6, wherein the method further includes surveying the potential customers to elicit indications of product purchasing preferences, website browsing behavior, and price elasticity.

12. The non-transitory computer readable medium of claim 11, wherein surveying includes conducting a focus group of potential customers.

13. The non-transitory computer readable medium of claim 6, wherein the method further includes determining product clusters and venue clusters using a soft clustering technique selected from a group comprising K-means, Probabilistic Latent Semantic Indexing, and latent Dirichlet.

14. The non-transitory computer readable medium of claim 6, wherein the method further includes sub-clustering the product and/or venue clusters based on a respective attribute that allows potential customers to be further segregated into groups.

15. A networked advertising system, comprising:
at least one server computing device communicatively coupled to the number of client computing devices, and having:
one or more processors;
non-transitory memory in communication with the one or more processors, the non-transitory memory being programmed with instructions executable on the one or more processors to:
cluster potential customers into a plurality of product clusters, each product cluster corresponding to one of a plurality of product classifications, each potential customer of a product cluster having indicated a preference for purchasing products of the corresponding product classification;
cluster potential customers of a product cluster into venue clusters based on likelihood of a potential customer of the product cluster to observe venues;
determine a price sensitivity for potential customers with respect to the venues;
select products to include in a particular advertisement based on a particular product classification; and
display the particular advertisement having content associated with the particular product classification at the venues,
wherein promotional pricing associated with the particular advertisement is determined based on the price sensitivity associated with the venues at which the particular advertisement is displayed.
